(19) United States
(12) Patent Application Publication
(10) Pub. No.: US 2017/0129224 A1
(43) Pub. Date: May 11, 2017

(54) PACKAGING COMPRISING A FRESH FOOD PRODUCE

(71) Applicant: DSM IP Assets B.V., Heerlen (NL)

(72) Inventor: Pascal Maria Hubert Pierre TIJSSEN, Echt (NL)

(21) Appl. No.: 15/321,932

(22) PCT Filed: Apr. 20, 2015
(86) PCT No.: PCT/EP2015/058521

§ 371 Date: Dec. 23, 2016

(30) Foreign Application Priority Data
Jun. 27, 2014 (EP) 14174724.6

(51) Int. Cl. B32B 27/08; B32B 27/28; B32B 27/36

(52) U.S. Cl. CPC B32B 27/08; B32B 27/36; B32B 27/285; B32B 2439/70; B32B 2250/02; B32B 2250/24; B32B 2307/308

(57) ABSTRACT

Packaging comprising a fresh food produce, characterized in that the packaging comprises a film, which film comprises a first layer consisting of a first polymer composition containing polyethylene terephthalate and a second layer consisting of a second polymer composition containing a thermoplastic copolyetherester elastomer containing at least 10 wt. % polyethylene oxide soft segments and the second layer being located at the inside of the packaging.

The invention relates to a packaging comprising a fresh food produce, more particularly a fresh food produce selected from vegetables, fruits, mushrooms, meat, cheese and fish. Fresh food produces are generally packaged for transport and storage in the supermarket. One aim of the packaging is to increase the shelf life of the fresh food produces. Another aim is to obtain an attractive and hygienic presentation of the fresh food produce.

Fresh food produces tend to dry out during storage. The drying out is restricted by the packaging. However, water vapor accumulates in the packaging and condensates, often as water droplets, against the inner surface of the packaging. This is also referred to as fogging. Fogging is undesirable, since microorganisms can grow in the condensate water and have a negative influence on the shelf life of the fresh food produce, especially if the fresh food produce comes into contact with the water. Another problem of the condensate water is that the visibility of the fresh food produce through the packaging, often a clear plastic film, is insufficient.

For example in case of vegetables and fruits one way of avoiding this problem is to use a packaging comprising perforations. The problem with such a packaging is that in order to avoid condensation a high amount of perforation or large perforations must be applied, so that the packaging loses a lot of water and the fresh food produce dries out fast again. And although the packaging comprises perforations, still anti-fogging or anti-misting treatments need to be applied underneath these films to control the formation of condensation to a certain extend.

Another way of solving this problem is described in WO2009/003675. In this patent publication describes the use of a packaging which has a high water vapor transmission rate. Again the problem is that the packaging loses a lot of water and the fresh food produce dries out fast.

Object of the invention is to provide a packaging comprising a fresh food produce that does not show above-mentioned problems.

Surprisingly this object is obtained if the packaging comprises a film, which film comprises a first layer consisting of a first polymer composition containing polyethylene terephthalate and a second layer consisting of a second polymer composition containing a thermoplastic copolyetherester elastomer containing at least 10 wt. % polyethylene oxide segments and the second layer being located at the inside of the packaging.

In DE 20 2010 008 675 U1 a packaging comprising a multilayer film, containing a first polymer layer and a second layer of a lower melting polymer. The film is used to close the packaging by melt sealing. The packaging can be opened again by peeling off the film. No second layer containing a thermoplastic copolyetherester elastomer containing polyethylene oxide segments has been described. Also the use of the packaging for fresh food has not been described, nor the problem of the accumulation of water vapour against the film.

The first polymer composition preferably comprises at least 90 wt. % of the polyethylene terephthalate, more preferably at least 98 wt. %.

The first polymer composition may further comprise usual additives.

Between the first and second layer preferably one or more tie layers are present. The skilled person knows what tie layers to choose.

The thermoplastic copolyetherester elastomer of the second polymer composition preferably contains hard segments containing butylene terephthalate units or ethylene terephthalate units. Preferably the hard segments contain butylene terephthalate units.

The second polymer composition preferably contains at least 50 wt. % of the thermoplastic polyetherester elastomer, more preferably at least 75 wt. %, even more preferably even more than 95 wt. %. The second polymer composition may comprise a second polymer. As second polymer the second polymer composition may comprise polybutylene terephthalate or polyethylene terephthalate.

The thermoplastic polyetherester elastomer may contain between 10 and 90 wt. % of the polyethylene oxide soft segments, preferably between 15 and 70 wt. %, more preferably between 20-60 wt. %, most preferably between 25 and 50 wt. %. This ensures good anti-fog properties and a good sealing properties of the packaging. The polyethylene oxide segments may be incorporated in the thermoplastic polyetherester elastomer as (poly(ethylene oxide))diol soft segments and/or (poly(ethylene oxide)/polypropylene oxide/polyethylene oxide)diol soft segments.

Next to above described hard segments and soft segments, the thermoplastic copolyetherester elastomer may comprise small amounts of further hard and/or soft segments. This is however not preferred.

The terms hard segments and soft segments in relation to thermoplastic polyetherester elastomers are well understood by the person skilled in the art. The soft segments are the polyether segments, having a weakening point below room temperature. The hard segments are the polyester segments, having a weakening temperature above room temperature.

The second polymer composition may further comprise usual additives.

Examples and preparation of copolyether esters are for example described in Handbook of Thermoplastics, ed. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996), ISBN 1-56990-205-4, in Encyclopedia of Polymer Science and Engineering, Vol. 12, Wiley & Sons, New York (1988), ISBN 0-471-80944, p.75-117, and the references cited therein.

Preferably the second polymer composition has a lower melting point than the first polymer composition to ensure good sealing properties of the film.

The thickness of the first layer may be between 5 microns and 100 microns. Preferably the thickness of the first layer is between 10 microns and 50 microns more preferably between 15 microns and 30 microns.

The thickness of the second layer may be between 1 micron and 100 microns. Preferably the thickness of the second layer is between 5 microns and 50 microns, more preferably between 10 microns and 30 microns.

The multi-layer packaging film according to the invention can be produced according to a coextrusion cast film process or a coextrusion blown film process. After coextrusion, the cast film is preferably biaxially oriented. The coextrusion blown film process can be a single bubble blown film process or a double or triple bubble blown film process. Preferably the blown film process is a double or triple blown film process, so that a biaxially oriented blown film has been produced. It is also possible to apply the second layer by lamination or extrusion coating onto the first layer, which preferably has been biaxially oriented before. These production processes are known to any person skilled in the art.

The multi-layer packaging film according to the invention may be printed.

In one preferred embodiment the packaging comprises a container having an open top, the packaging comprising a fresh food produce and the film according to the invention closing the open top of the container. The film may be being tightened over the fresh food produce to secure the fresh food produce in the container and so having contact areas between the fresh food produce and the first layer of the film. The container may be a box, a punnet, a basket, a tray, a platter, etc.

In a second preferred embodiment the packaging is a bag of the film according to the invention containing the fresh food produce. Such a packaging may be used in a so called vertical form, fill and seal process (VFFS).

In a second preferred embodiment the packaging comprises a bag of the film according to the invention, containing a container with an open top, containing the fresh food produce. Such a packaging may be used in a so-called horizontal form, fill and seal process (HFFS).

The film may comprise perforations, preferably in the form of micro-perforations that may have a diameter of between 50 microns and 500 microns, preferably between 75 and 125 microns. The density of the perforations may be up to about 1000 per m², preferably up to about 500 m². Perforation may take place either in a continuous or in a batch process. For example, the perforation may be effected by contacting the film with one or more rollers comprising pins or needles to punch the perforations. Preferably the perforation is effected by use of laser technology. The perforation may take place in line with the production of the film.

Fresh food produces that may be stored in the packaging according to the invention generally include fresh food produces with a high respiration rate and therefore short shelf life times. Cut vegetables and fruits are particularly sensitive as the respiration rate goes up compared to the whole fruits and vegetables.

The invention will be further explained in the Figure.

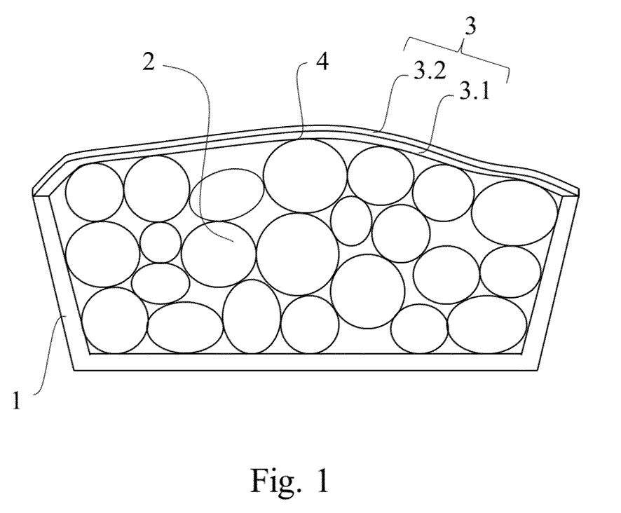

FIG. 1 is schematic intersection of one of the embodiments of the invention, it is a container having an open top and a film according to the invention closing the open top of the container.

In FIG. 1 a schematic intersection of a box comprising mushrooms is shown. The box (1) is just more than fully loaded with mushrooms (2). The mushrooms stick somewhat out the box, so that the mushrooms are secured in the box by tightening the film (3) over the mushrooms, so to create contact areas (4) between the film and the mushrooms. The second layer of the film (3.1.) is located at the inside of the packaging. The first layer of the film (3.2.) is located at the outside of the packaging.

### Experimental.

### Materials Used:

TPEE-A, a thermoplastic polyetherester elastomer containing 35 wt. % polyethylene oxide soft segments incorporated as (poly(ethylene oxide))diol.

TPEE-B: a thermoplastic polyetherester elastomer containing 16.5 wt. % polyethylene oxide soft segments incorporated as (poly(ethylene oxide)/polypropylene oxide/polyethylene oxide)diol soft segments.

TPEE-C: a thermoplastic polyetherester elastomer containing 12 wt. % polyethylene oxide soft segments incorporated as(poly(ethylene oxide)/polypropylene oxide/polyethylene oxide)diol soft segments.

TPEE-D a thermoplastic polyetherester elastomer containing 6 wt. % polyethylene oxide soft segments, delivered by DSM in de Netherlands.

TPEE-E a thermoplastic polyetherester elastomer containing 60 wt. % polytetramethyleneoxide soft segments, delivered by DSM in de Netherlands.

Biaxial oriented polyethylene terephthalate (BOPET) and biaxial oriented polyamide 6 (BOPA) films where used a first layer. These films are widely commercially available.

### Preparation of Films.

Preparation of clear Arnitel™ films has been done on a single screw cast films extrusion machine with a smooth chill roll pressure roll combination for optimal transparency of the films. CESA®-block GEA0025533-ZA supplied by Clariant was used in 1 wt. % addition to prevent blocking of the processed films. Thickness of the transparent Amite!™ films was 20 microns

In a second step the transparent Arnitel™ films have been laminated onto a 23 micron BOPET film. Lamination was done with a Liofol solvent free glue supplied by Henkel. The glue was applied in a layer of 2 grams/M2.

### Tests.

Anti-fog tests have been done by the following procedure: A jar covered by a lid and filled with water until 2 cm under the top is placed in an oven at 70° C. until the water reaches a temperature of 65° C. The jar is removed from the oven and after removal of the lid the jar is immediately covered with the film. Fog formation is detected visually and the time after which the fog or water droplet are formed is recorded. Maximum cover time is 15 seconds. If fogging occurs after one second or less, the multilayer does not fulfill the requirements.

### EXAMPLE I

Films according to the invention containing a first layer of BOPET and a second layer of a second polymer composition containing TPEE-A, containing 35 wt. % of poly ethylene oxide (PEO) soft segments was produced and tested as described above. The test results are given in table 1.

### EXAMPLE II

Films according to the invention containing a first layer of BOPET and a second layer of a second polymer composition containing TPEE-B, containing 16.5 wt. % polyethylene oxide soft segments was produced and tested as described above. The test results are given in table 1.

### EXAMPLE III

Films according to the invention containing a first layer of a BOPET and a second layer of a second polymer composition containing TPEE-B, containing 12 wt. % polyethylene oxide soft segments was produced and tested as described above. The test results are given in table 1.

### Comparative Experiment A.

Films according to the invention containing a first layer of BOPET and a second layer of a second polymer composition containing TPEE-D, containing 6 wt. % polyethylene oxide soft segments was produced and tested as described above. The test results are given in table 1.

### Comparative Experiment B.

Films according to the invention containing a first layer of BOPET and a second layer of a second polymer composition containing TPEE-E, containing polytetramethyleneoxide soft segments was produced and tested as described above. The test results are given in table 1.

TABLE 1

| | | Second layer/content | | |
|---|---|---|---|---|
| | First | PEO* segments | | Time |
| | layer | (wt. %) | Fog present | (seconds) |
| Example | | | | |
| I | BOPET | TPEE-A, 35 wt. % | NO | — |
| | | PEO | | |
| II | BOPET | TPEE-B, 16.5 wt. % | YES | 10 |
| | | PEO | | |
| II | BOPET | TPEE-C, 12 wt. % | YES | 3 |
| | | PEO | | |
| Comparative | | | | |
| Example | | | | |
| A | BOPET | TPEE-D, 6 wt. % PEO | Yes | 1 |
| B | BOPET | TPEE-E, 0 wt. % PEO | Yes | <1 |

*PEO = polyethylene oxide.

From the comparison with comparative experiments A, B and Examples I-III it is clear that the films containing a second layer consisting of a polymer composition containing the thermoplastic polyetherester with at least 10 wt. % of polyethylene oxide soft segments show a higher resistance against fog formation. The film containing the second layer with the second polymer composition containing the thermoplastic polyetherester containing polyethylene oxide soft segments incorporated as (polyethylene oxide)diol soft segments show the highest resistance against fog formation.

1. Packaging comprising a fresh food produce, wherein the packaging comprises a film, which film comprises a first layer consisting of a first polymer composition containing polyethylene terephthalate and a second layer consisting of a second polymer composition containing a thermoplastic copolyetherester elastomer containing at least 10 wt. % polyethylene oxide soft segments and the second layer being located at the inside of the packaging.

2. Packaging according to claim 1, wherein the thermoplastic copolyetherester elastomer contains 15-70 wt. % polyethylene oxide soft segments.

3. Packaging according to claim 1, wherein the second polymer composition contains a thermoplastic copolyetherester elastomer containing poly(ethylene oxide)diol soft segments.

4. Packaging according to claim 1, wherein the first layer has a thickness between 1 and 100 microns.

5. A packaging according to claim 1, wherein the first layer has a thickness between 5 and 50 microns.

6. A packaging according to claim 1, wherein the second layer has a thickness between 5 and 100 microns

7. A packaging according to claim 1, wherein the second layer has a thickness between 10 and 50 microns

8. A packaging according to claim 1, wherein the first layer is biaxially oriented.

9. A packaging according to claim 1, wherein the melting point of the first polymer composition is higher than the melting point of the second polymer composition.
